(19) United States
(12) Patent Application Publication
(10) Pub. No.: US 2018/0001424 A1
(43) Pub. Date: Jan. 4, 2018

(54) ADDITIVE PRODUCTION METHOD USING THICKER POWDER LAYERS, AND COMPONENT

(71) Applicant: Siemens Aktiengesellschaft, München (DE)

(72) Inventors: Christian Brunhuber, Auerbach (DE); David Regnery, Duisburg (DE); Thomas Soller, Deggendorf (DE)

(73) Assignee: Siemens Aktiengesellschaft, München (DE)

(21) Appl. No.: 15/544,161

(22) PCT Filed: Jan. 13, 2016
(86) PCT No.: PCT/EP2016/050550

§ 371 Date: Jul. 17, 2017

(30) Foreign Application Priority Data
Jan. 30, 2015 (DE) 10 2015 201 686.2

(51) Int. Cl. B23K 26/342; B23K 26/144; B33Y 10/00; B33Y 70/00; B22F 1/00; B23K 26/70

(52) U.S. Cl. CPC B23K 26/342; B22F 1/0014; B23K 26/70; B33Y 10/00; B33Y 70/00; B23K 26/144

(57) ABSTRACT

The manufacturing rate of selective production methods is increased by using thicker powder layers.

### CROSS-REFERENCE TO RELATED APPLICATIONS

This application claims priority to PCT Application No. PCT/EP2016/050550, having a filing date of Jan. 13, 2016, based off of German application No. DE 102015204686.2 having a filing date of Jan. 30, 2015, the entire contents of both which are hereby incorporated by reference.

### FIELD OF TECHNOLOGY

The following relates to a method or to a component from the field of additive manufacturing (AM), in which thick powder layers are used in order to accelerate the manufacturing process.

### BACKGROUND

Beam melting processes such as selective laser melting (SLM) or electron beam melting (EBM) currently constitute the technology of choice in order to produce complex gas turbine components, especially burner parts. On account of the relatively small layer thicknesses of about 0.05 mm, which are required due to the sought-after accuracies, and on account of the time-intensive deposition of these thin layers as a result of placement by means of a doctor blade or roller, slow construction speeds result. The slow construction speeds (˜20 cm³/h) are the causes for many components being able to be more favorably produced in the conventional manner at the present time.

Various technical solutions are envisaged for accelerating the process. The majority of manufacturers seek to curtail the construction speeds by means of high laser performances and by integration of a plurality of lasers (multi-beam). As a result of this procedure, however, the risk of thermo-mechanically induced stresses and distortions in the component increases.

### SUMMARY

An aspect relates to solving the aforesaid problem.

An aspect relates to a method for producing a component, in which powder in layers is deposited as a powder layer (and is selectively compacted, especially selectively melted, wherein thick powder layers of at least mm are deposited at least partially and at least in layers and compacted, especially melted.

### BRIEF DESCRIPTION

Some of the embodiments will be described in detail, with reference to the following figures, wherein like designations denote like members, wherein:

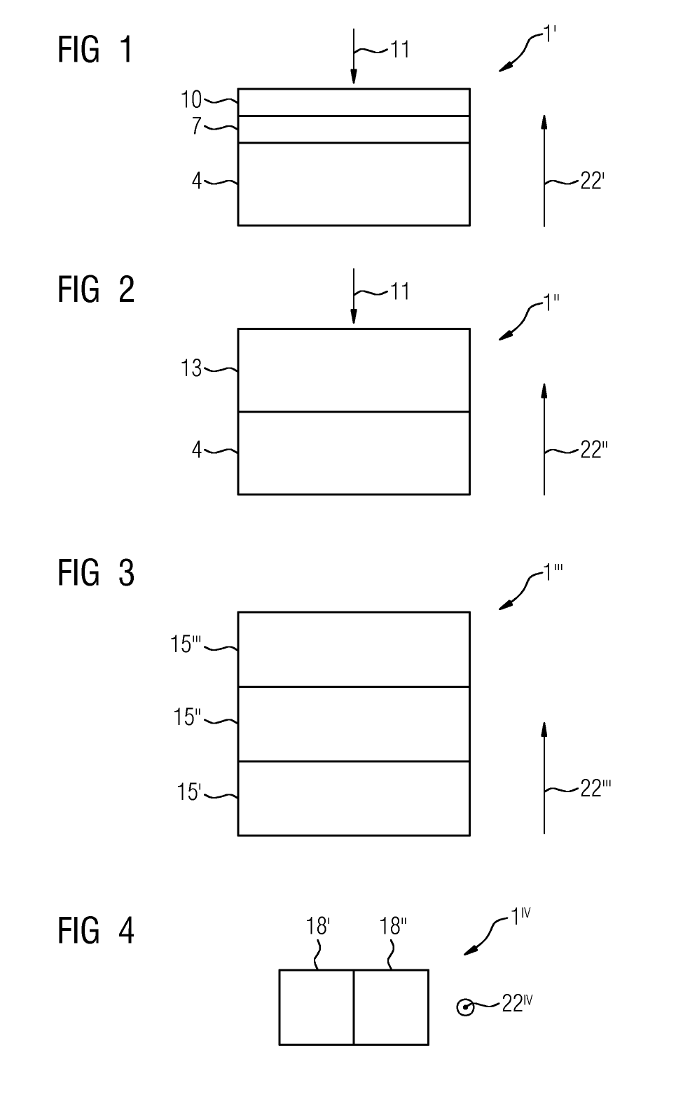

FIG. 1 shows a first procedure, in accordance with embodiments of the present invention

FIG. 2 shows a second procedure, in accordance with embodiments of the present invention;

FIG. 3 shows a component in cross section with different sections, in accordance with embodiments of the present invention.

The description and figures only represent exemplary embodiments of the invention.

### DETAILED DESCRIPTION

Embodiments of the invention are based on the idea of accelerating the time-consuming step of powder deposition. In this case, in addition to the frequently used grain sizes in the region of 0.025-0.045 mm, which are required for generating finer structures, one or more coarser powder fractions, i.e. with grain sizes for example in the region of at least 0.1 mm, are preferably also used.

In a specific embodiment of the invention, the one or more coarse powder fractions contains, or contain, non-spherical, preferably oblate and/or prolate particles in order to obtain a highest possible packing density and therefore the best possible heat transfer inside the layer.

The one or more coarser powder fractions can be deposited by means of a doctor blade which works perpendicularly to the doctor blade for the finer powder and the powder deposit would need to be correspondingly arranged. The beam output of the additive manufacturing process, preferably of the SLM process, and the lowering of the construction platform are adapted depending on the deposited powder layer thickness.

An inventive step lies especially in the use of a second powder (with monomodal or multimodal grain size distribution) with larger metal particles in the additive manufacturing process. For components, or in sections of components, in which the contour accuracy permits a coarser powder deposition, a significant speed advantage would ensue. In the case of a powder with grain sizes in the region of at least 0.1 mm, the powder deposition would be 2-4 times as quick as for powders with grain sizes in the region of 0.025-0.045 mm.

Furthermore, by optimizing morphology and grain size composition of the second powder a higher packing density and therefore a faster and more defect-low melting are possible, which additionally improves the construction rate and construction quality.

FIG. 1 shows the procedure according to embodiments of the invention.

The component which is to be produced has a substrate 4 on which is deposited in a deposition direction 22′ material in powder form according to an additive manufacturing process. In this case, a thick layer of at least 0.1 mm is achieved by a plurality of layers 7, 10, in which a corresponding doctor blade gap width is established or the doctor blade repeatedly travels over already existing powder layers which are not yet beam-melted.

The powder layers 7, 10 have powders with grain sizes ≦50 μm. By means of a matched melting beam 11 the thick powder layer 7, 10 is melted, wherein the melting is carried out selectively in order to achieve a determined contour of the component 1′ which is to be produced.

FIG. 2 shows a further procedure in which in comparison to FIG. 1 a thick powder layer 13 is similarly created, wherein in this case, however, a powder layer 13 which preferably has coarser particles is used. The coarser particles preferably have a minimum grain size of 0.1 mm.

This powder layer 13 with the coarser powder grains is also melted by means of a melting beam 11 in order to create a component 1″.

FIG. 3 shows a component 1′− in cross section with different sections, in which in a first end section 15′ thin powder layers, i.e. considerably smaller than 0.1 mm, are used in order to achieve a certain contour accuracy, and in the other end section 15′″ coarser particles or a plurality of powder layers are used according to the procedure of FIGS. 1 and 2 since the contour accuracy is not quite so necessary in this section 15′″. In a middle section 15″, which may possibly exist, the procedure according to the section 15′ or 15′″, or a combination thereof, is used.

FIG. 4 shows a top view of a component 1^{IV} in the deposition direction 22^{IV}, in which in an outer section 18′ a higher contour accuracy than in the other section 18′ is to be achieved so that thin powder layers, i.e. ≦50 μm, are used there and in another section 18″ the procedure according to FIG. 1 or FIG. 2 is selected.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for producing a component, in which powder in layers is deposited as a thick powder layer and is selectively compacted, wherein the thick powder layers is at least 0.1 mm and is deposited at least partially and at least in layers and compacted.

2. The method as claimed in claim 1, thick powder layer is is comprised of fine powders with a grain size of >50 μm.

3. The method as claimed in claim 2, wherein the thick powder layer is deposited in one operation.

4. The method as claimed in claim 2, wherein the thick powder layer is achieved by deposition of a plurality of powder layers.

5. The method as claimed in claim 1, wherein grain sizes of at least 0.1 mm are used in order to achieve the thick powder layer.

6. The method as claimed in claim 1, wherein prolate and/or oblate powder particles are used.

7. The method as claimed in claim 1, wherein the deposition of the powder layers is carried out by means of two doctor blades, which in particular are arranged perpendicularly to each other.

8. The method as claimed in claim 1, wherein as powder a powder mixture is used.

9. A component produced by means of a method according to claim 1, which has different regions and at least one region differs with regard to a thickness of the powder layer which is to be compacted, and correspondingly has a different roughness.

10. The method of claim 1, wherein the thick powder layer is melted.
